(19) United States
(12) Patent Application Publication
(10) Pub. No.: US 2020/0016639 A1
(43) Pub. Date: Jan. 16, 2020

(54) SYSTEM AND METHOD FOR MANAGING A FLUID IN AN ENCLOSURE

(71) Applicant: CleanTech Systems, LLC, Arnaudville, LA (US)

(72) Inventor: David Ball, Arnaudville, LA (US)

(73) Assignee: CleanTech Systems, LLC, Arnaudville, LA (US)

(21) Appl. No.: 16/036,864

(22) Filed: Jul. 16, 2018

(51) Int. Cl. B08B 9/093; B05B 13/06; B25J 11/00; B25J 9/00; B25J 9/06

(52) U.S. Cl. CPC B08B 9/0936; B05B 13/0636; B05B 15/652; B25J 9/0009; B25J 9/06; B25J 11/0085

(57) ABSTRACT

A tank system includes a primary arm and a secondary arm mounted on a trolley. Each arm is configured to independently rotate 340 to 360 degrees in horizontal planes. The primary arm includes a pivot frame for adjusting the vertical position of the secondary arm by pivoting the primary arm in a vertical plane. At least one nozzle and a submersible pump are mounted to the secondary arm. The tank system is mounted within a tank or other enclosure by securing the trolley to a track system within the tank or other enclosure. The trolley is configured to move along the track system within the tank or other enclosure. The tank system may pump a fluid from the tank in a pumping configuration, mix the fluid within the tank in a mixing configuration, and/or clean the tank in a cleaning configuration.

### BACKGROUND

Liquids are stored in tanks and other containers. For example, tanks on boats and drilling rigs are used to store and transport drilling fluids (or drilling muds), which typically include additives in the form of solids, liquids, or gels. The drilling fluids are removed from tanks with pumping systems, but conventional vessel pumping systems do not allow the complete removal of drilling fluid from tanks. The process of cleaning these tanks can also be difficult and costly. The cleaning process is especially difficult when solid additives have separated from the drilling fluid slurry or suspension. Personnel often manually clean these tanks by climbing inside and using water hoses, bushes, and other tools to clean the internal surfaces.

### BRIEF DESCRIPTION OF THE DRAWINGS

FIG. 1 is a perspective view of a tank system.

FIG. 2 is a perspective view of the tank system with a primary arm of the tank system in a lower tilted position.

FIG. 3 is a top view of the tank system.

FIG. 4 is a top view of the tank system with the primary arm rotated relative to the position in FIG. 3.

FIG. 5 is a top view of the tank system with a secondary arm rotated relative to the position in FIG. 4.

FIG. 6 is a perspective view of the tank system in a mixing configuration.

FIG. 7 is a perspective view of the tank system in a pumping configuration.

FIG. 8 is a perspective view of the tank system in a cleaning configuration.

FIG. 9 is a perspective view of the tank system in a storage position.

FIG. 10 is a perspective view of an alternate embodiment of the tank system.

FIG. 11 is a side view of a second alternate embodiment of the tank system.

FIG. 12 is a side view of the second alternate embodiment of the tank system with a primary arm in a lower tilted position.

FIG. 13 is a side view of the second alternate embodiment of the tank system in a storage position.

### DETAILED DESCRIPTION OF THE PREFERRED EMBODIMENTS

As used herein, “fluid” shall include a liquid, a suspension, a slurry, or any other combination of solids in a liquid.

A tank system includes a primary arm and a secondary arm mounted on a trolley. Each arm is configured to independently rotate 340 to 360 degrees in horizontal planes, or any subrange therein. The primary arm includes a pivot frame for adjusting the vertical position of the secondary arm by pivoting the primary arm in a vertical plane. The vertical plane is any plane that intersects with the horizontal plane at an angle between 45 and 90 degrees, or any subrange therein, including but not limited to any plane that is perpendicular to the horizontal plane. At least one nozzle and a submersible pump are mounted to the secondary arm. The tank system is mounted within a tank or other enclosure by securing the trolley to a track system within the tank or other enclosure. The trolley is configured to move along the track system within the tank or other enclosure. The tank system may be used to pump a fluid from the tank in a pumping configuration, to mix the fluid within the tank in a mixing configuration, and/or to clean the tank in a cleaning configuration. The tank system may be used in any tank or other enclosure with any fluid in any industry or application.

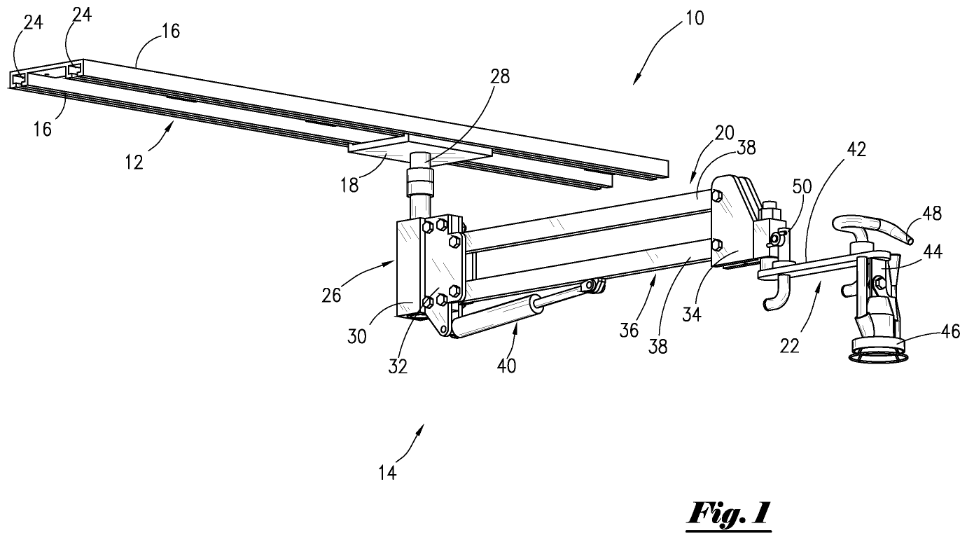

FIG. 1 illustrates one embodiment of the tank system. Tank system 10 includes track assembly 12 and arm assembly 14. Track assembly 12 includes one or more rails 16, which may be mounted in a tank or other enclosure. For example, rails 16 may be mounted across an upper portion of a tank, on a side wall of the tank, or on a bottom surface or floor of the tank. Arm assembly 14 includes trolley 18, primary arm 20, and secondary arm 22. Trolley 18 is operatively mounted to the one or more rails 16 of track assembly 12. In one embodiment, the lower surface of each rail 16 may include slot 24 extending substantially the length of rail 16, and a portion of trolley 18 may extend through each slot 24 to slidingly mount trolley 18 to rails 16. For example, a gear, lead screw, shaft, or any other mechanism may be employed to provide sliding movement of trolley 18 along rails 16.

Primary arm 20 is mounted to trolley 18 through swivel frame 26. Swivel frame 26 includes upper portion 28 fixedly mounted to trolley 18 and lower portion 30 rotatably mounted to upper portion 28. Lower portion 30 may include a rod rotatably secured to upper portion 28 and a frame fixedly mounted to the rod. In the embodiment in which rails 16 are mounted in an upper portion of a tank, swivel frame 26 may be suspended from a lower surface of trolley 18. In other embodiments, swivel frame 26 is mounted to trolley 18 in a configuration allowing for movement of primary arm 20 and secondary arm 22 within the tank.

Primary arm 20 may be mounted to lower portion 30 of swivel frame 26. Primary arm 20 and lower portion 30 of swivel frame 26 may rotate 360 degrees in a horizontal plane relative to trolley 18. Primary arm 20 may include proximal bracket 32 and distal bracket 34 interconnected by pivot frame 36. Pivot frame 36 may include two parallel members 38 each pivotally mounted to proximal bracket 32 and distal bracket 34. Pivot frame 36 may further include cylinder assembly 40. In the embodiment illustrated in FIG. 1, cylinder assembly 40 may be pivotally mounted to proximal bracket 32 and the lower parallel member 38. Cylinder assembly 40 may be hydraulically powered, electrically powered, or air driven.

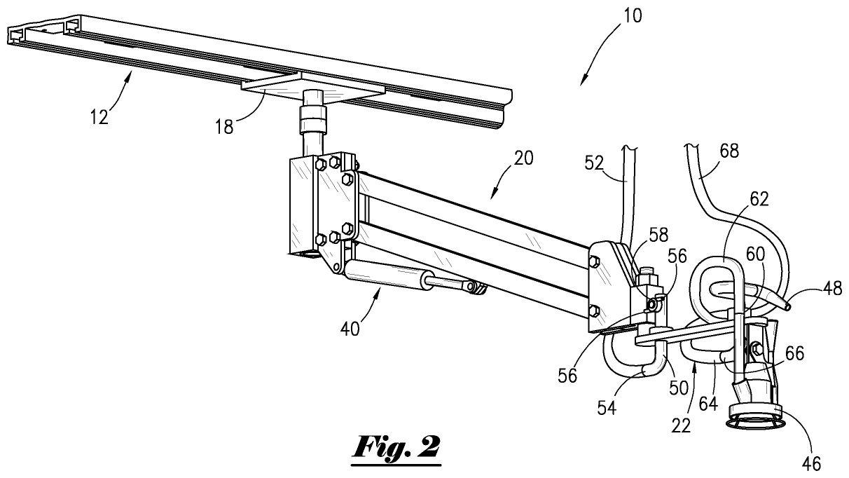

In the embodiment illustrated, extension of cylinder assembly 40 pivots primary arm 20 downward to the position shown in FIG. 2, and retraction of cylinder assembly 40 pivots primary arm 20 upward to the position shown in FIG. 1. In other words, extension of cylinder assembly 40 moves distal bracket 34 downward, and retraction of cylinder assembly 40 moves distal bracket 34 upward. In one embodiment, lower portion 30 of swivel frame 26 may be integrally formed with proximal bracket 32 of primary arm 20.

In the embodiment illustrated in FIGS. 1 and 2, secondary arm 22 includes horizontal member 42 and vertical member 44. A proximal end of horizontal member 42 is rotatably mounted to distal bracket 34 of primary arm 20, such as with a swivel connection or any other connection mechanism configured for relative rotation. Secondary arm 22 may rotate at least 340 degrees in a horizontal plane relative to primary arm 20. Alternatively, secondary arm 22 may rotate at least 315 degrees in a horizontal plane relative to primary arm 20. At least one nozzle and a submersible pump may be mounted to secondary arm 22. In one embodiment, submersible pump 46 may be mounted to a distal end of vertical member 44 of secondary arm 22, and recirculation nozzle 48 and cleaning nozzle 50 may be mounted to horizontal member 42 of secondary arm 22. Submersible pump 46 may be any pump configured to pump a fluid including solid components. One example of a suitable submersible pump is a portable cargo pump model TK80 commercially available from Framo. Recirculation nozzle 48 may be any nozzle with or without a monitor configured for high pressure fluid flow. One example of a suitable recirculation nozzle may be the nozzle of a Severe-Duty Monitor™ commercially available from Akron Brass Company. Cleaning nozzle 50 may be any nozzle configured for rotation of the nozzle outlet(s) and for high pressure fluid flow. For example, a suitable cleaning nozzle 50 may be a Cloud™ spherical series tank cleaner commercially available from Sellers® Cleaning Systems.

With reference to FIG. 2, inlet fluid line 52 may be connected to inlet 54 of cleaning nozzle 50. Cleaning nozzle 50 may include two outlets 56 mounted on a rotating frame 58. In a cleaning configuration of tank system 10, a cleaning fluid may be fed through inlet fluid line 52 and to cleaning nozzle 50. The pressure of the fluid flow may cause rotating frame 58 to spin as the cleaning fluid flows exists through both outlets 56. Alternatively, a gear may cause rotating frame 58 to spin. The spinning of rotating frame 58 allows tank system 10 to direct cleaning fluid at all surfaces within a tank. The movement of trolley 18 along track assembly 12, the rotation of secondary arm 22 relative to primary arm 20, the rotation of primary arm 20 relative to trolley 18, and the pivoting movement of primary frame 20 each enhances the ability of tank system 10 to direct cleaning fluid at all surfaces within the tank.

Valve 60 may also be mounted on secondary arm 22. Pump fluid line 62 may be fluidly connected between an outlet of submersible pump 46 and an inlet of valve 60. Nozzle fluid line 64 may be fluidly connected between an outlet of valve 60 and inlet 66 of recirculation nozzle 48. Outlet fluid line 68 may be fluidly connected to a second outlet of valve 60.

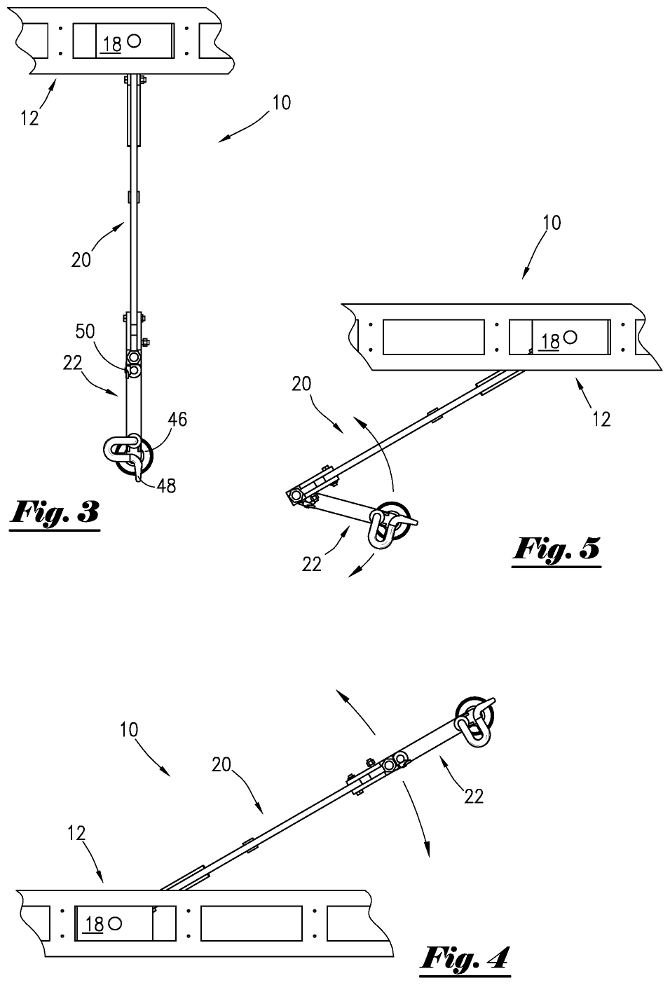

FIG. 3 is a top view of tank system 10 showing primary arm 20 and secondary arm 22 in aligned in the horizontal direction. As shown in FIG. 4, primary arm 20 and secondary arm 22 may rotate together in the horizontal direction relative to trolley 18 by activating swivel frame 26. As shown in FIG. 5, secondary arm 22 may rotate in the horizontal direction relative to primary arm 20 by activating the swivel connection between distal bracket 34 of primary arm 20 and horizontal member 42 of secondary arm 22. The movement illustrated in FIGS. 3-5, along with the movement of trolley 18 along track assembly 12, enables submersible pump 46, cleaning nozzle 50, and recirculation nozzle 48 of tank system 10 to cover the surfaces of entire tank or a substantial portion of the entire tank.

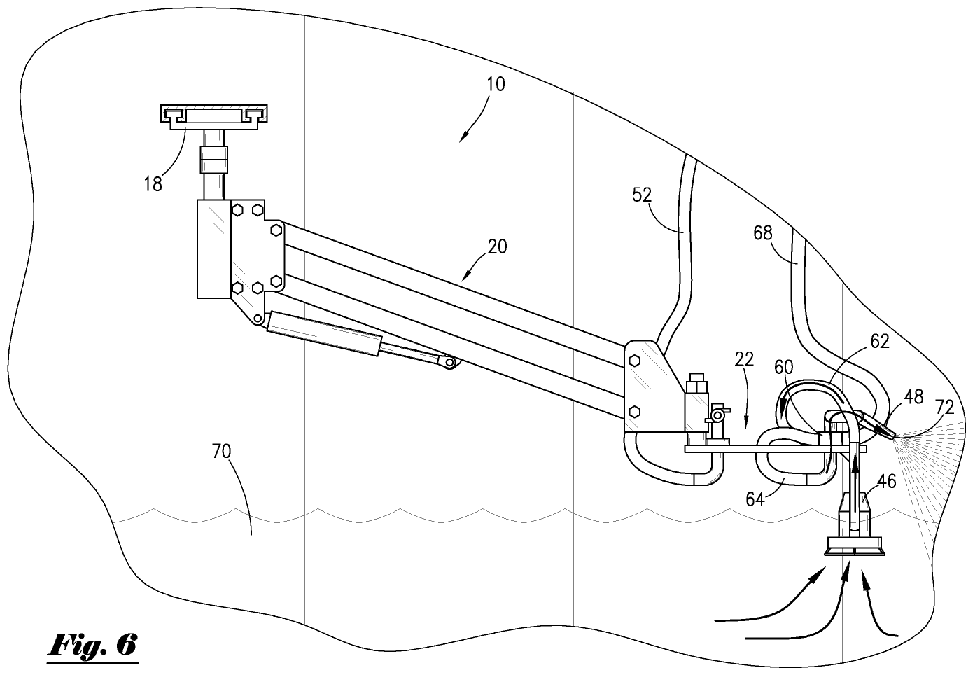

FIG. 6 illustrates tank system 10 in a mixing configuration within a tank. In this configuration, valve 60 may be set to a first position in which only the outlet leading to recirculation nozzle 48 is open. Submersible pump 46 may be positioned at least partially within fluid 70, which is drawn through submersible pump 46 and pump fluid line 62. Valve 60 directs this fluid flow from pump fluid line 62 to recirculation nozzle 48 and through outlet 72 of recirculation nozzle 48 for mixing fluid 70 within the tank. Tank system 10 mixes fluid 70 by recirculating fluid 70 completely within the tank; in other words, fluid 70 does not leave the tank during mixing operations. Submersible pump 46 and recirculation nozzle 48 are moved within the tank by trolly 18 sliding along the track assembly within the tank, by primary arm 20 rotating relative to trolley 18, and by secondary arm 22 rotating relative to primary arm 20. The track assembly may be secured within the tank by any means, including a bolted connection or magnetic connection.

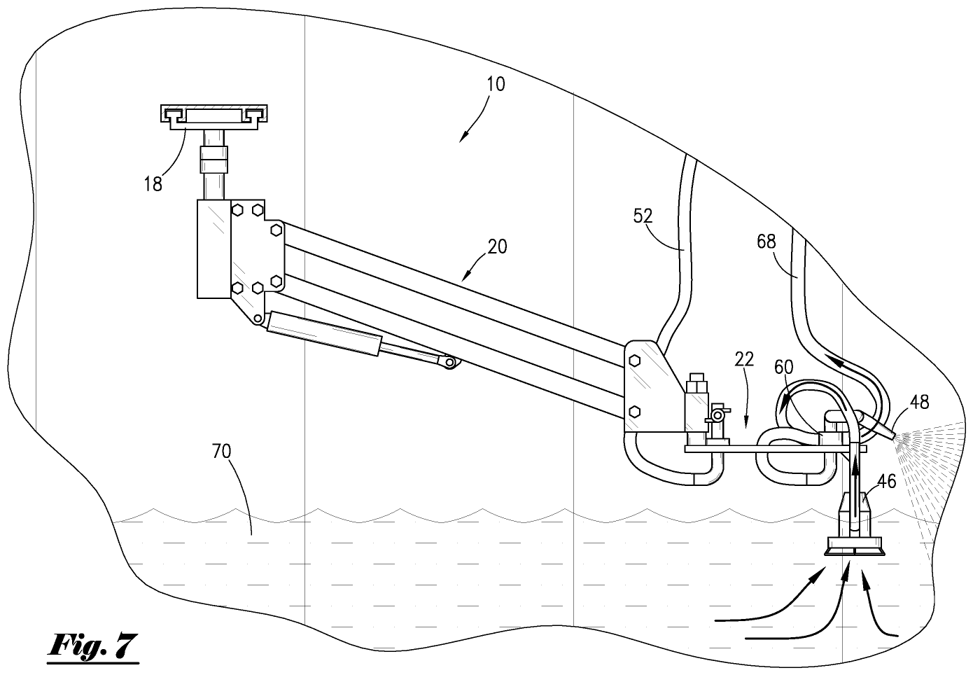

FIG. 7 illustrates a pumping configuration of tank system 10. Valve 60 may be set to a second position in which only the outlet leading to outlet fluid line 68 is open. With submersible pump 46 positioned at least partially within fluid 70, fluid 70 may be drawn through submersible pump 46 and pump fluid line 62. Valve 60 directs this fluid flow from pump fluid line 62 to outlet fluid line 68 for pumping fluid 70 out of the tank. For example, tank system 10 may be used in the pumping configuration to independently pump a fluid from a vessel to onshore or offshore facilities. Tank system 10 may be configured to remove nearly all fluid from a tank. For example, tank system 10 may be configured to remove 80% to 100% of fluid from a tank, or any subrange therein. In another embodiment, tank system 10 may be configured to remove 90% to 95% of fluid from a tank, or any subrange therein.

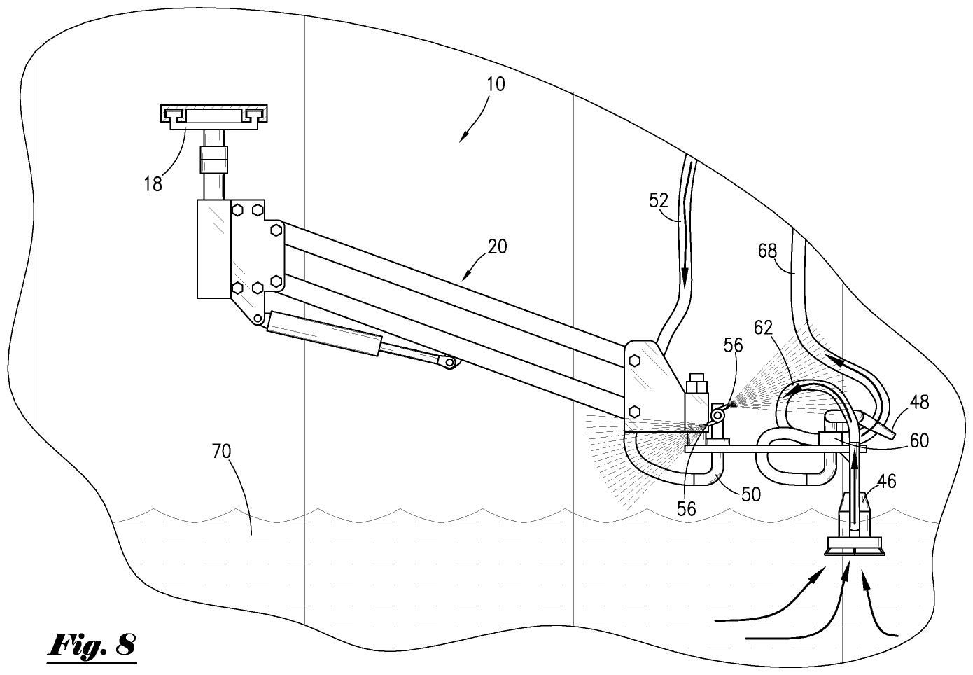

FIG. 8 illustrates a cleaning configuration of tank system 10. A cleaning fluid may be introduced through inlet fluid line 52 to cleaning nozzle 50. As the cleaning fluid flows through outlets 56 of cleaning nozzle 50, rotating frame 58 may rotate 360 degrees to spray the cleaning fluid on all surfaces within the tank. If any fluid 70 is present within the tank, submersible pump 46 may be positioned at least partially within fluid 70 to draw fluid 70 through submersible pump 46, pump fluid line 62, valve 60 in the second position, and outlet fluid line 68. In this way, tank system 10 provides a tank cleaning system that does not require personnel to enter the tank.

Cleaning nozzle 50 and/or recirculation nozzle 48 may be used to introduce another fluid to a tank. For example, cleaning nozzle 50 and/or recirculation nozzle 48 may be used to introduce a lower density fluid into a tank containing a higher density fluid, in order to facilitate the removal of the fluid from the tank (i.e., to increase the pumpability of the fluid through submersible pump 46).

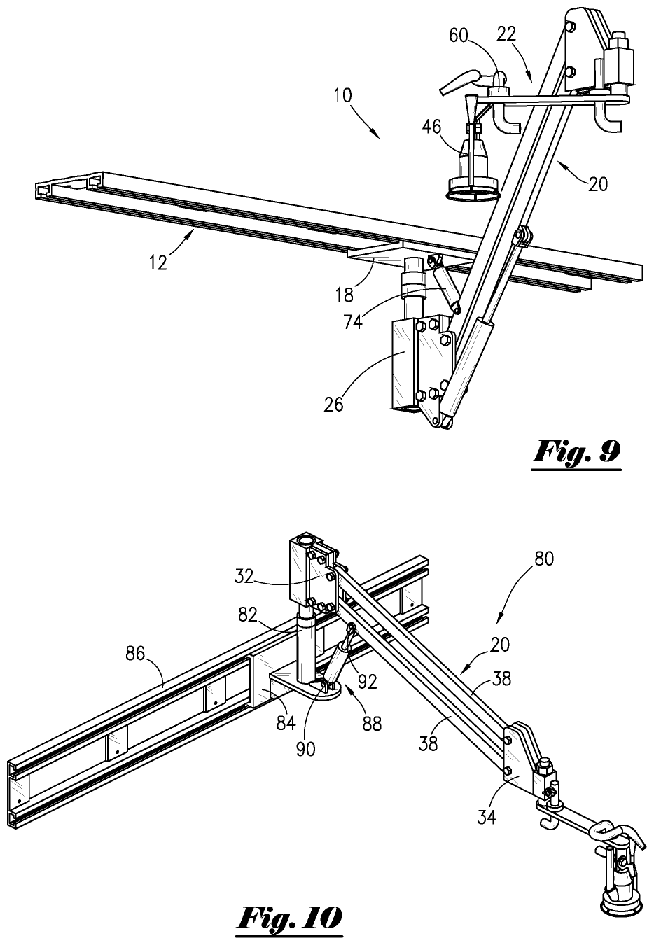

With reference to FIG. 9, tank system 10 may further include a secondary cylinder 74 for pivoting primary arm 20 into the upward tilted position, thereby placing tank system 10 in a storage position. In the storage position, secondary arm 22 may be rotated relative to primary arm 20 to position submersible pump 46 near primary bracket of primary arm 20. Accordingly, tank system 10 in the storage position occupies a minimum volume within the tank to reduce the impact on tank function. In one embodiment, submersible pump 46 is lifted between 70 and 99 percent, or any subrange therein, of the height of the tank from the position shown in FIGS. 6-8 to the storage position illustrated in FIG. 9.

The position of trolley 18 along track assembly 12, the rotation of the swivel connection between swivel frame 26 and trolley 18, the rotation of the swivel connection between primary arm 20 and secondary arm 22, the extension and retraction of cylinder assembly 40, and the position of valve 60 may each be controlled remotely and/or automated. For example, the trolly and submersible pump may be hydraulically controlled, and the nozzle may be controlled by air or electrical means. The tank system includes a control system for detecting or measuring properties within a tank and for adapting the operation of the tank system to accomplish the necessary functions. For example, the primary and secondary arms move in a predefined pattern that covers all areas and/or surfaces within a tank. When the fluid level in the tank drops to a certain level, the submersible pump automatically stops.

The control system may include a software program operating in a CPU (central processing unit) for controlling the movement and operation of the tank system. The dimensions and other characteristics of a tank may be inputted into the software program. The level and features, such as density, of the tank contents may be detected by a detection mechanism and inputted into the software program. The detection system may be an infrared system, an acoustic system, a seismic system, or any other system configured to detect characteristics of the tank contents and automatically input the measurements into the software program. For example, the detection system may detect the level of the tank contents and input the level measurement into the software program, which directs the control system to adjust the settings of the tank system to raise or lower the submersible pump. The detection system may also detect the density of the tank contents and input the density measurement into the software program, which directs the control system to adjust the settings of the tank system to place the tank in the mixing configuration. The detection system may also detect a non-level surface of the tank contents (indicating solid contents extending above a liquid surface, if the tank is level) and input the non-level measurement into the software program, which directs the control system to adjust the settings of the tank system to mix or clean the tank completely.

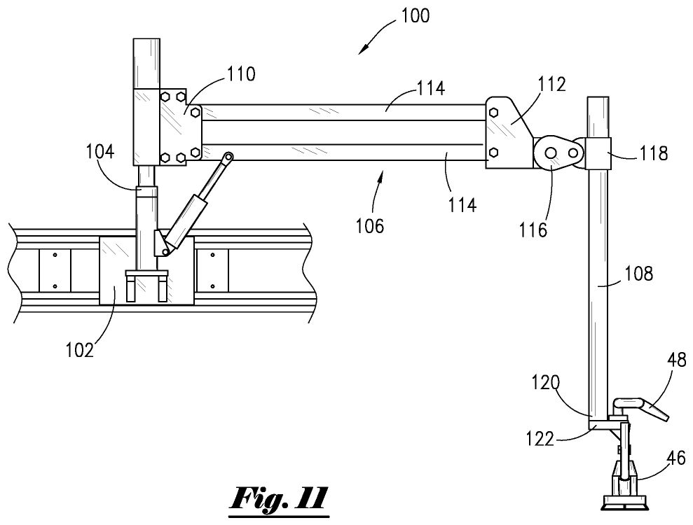

FIG. 10 illustrates an alternate embodiment of the tank system. Tank system 80 includes the same features and components, and functions in the same way, as tank system 10 except as otherwise described. Tank system 80 includes swivel frame 82 configured to attach to the side of trolley 84, which engages track assembly 86. Primary arm 20 includes proximal bracket 32, distal bracket 34, and parallel members 38. Cylinder assembly 88 is configured to pivot primary arm 20 in a vertical direction. Lower end 90 of cylinder assembly is affixed to swivel frame 82 and upper end 92 of cylinder assembly 88 is affixed to the lower parallel member 38. In this embodiment, extension of cylinder assembly 88 lifts distal bracket 34 to pivot primary arm 20 upward, and retraction of cylinder assembly 88 lowers distal bracket 34 to pivot primary arm 20 downward.

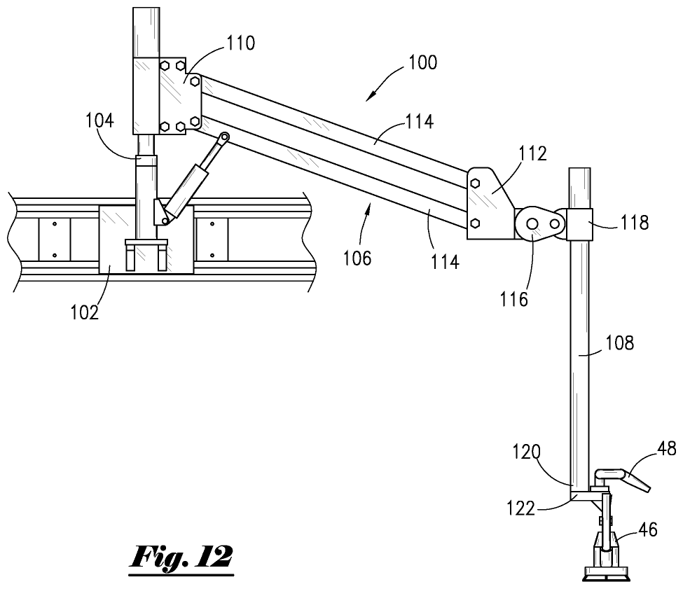

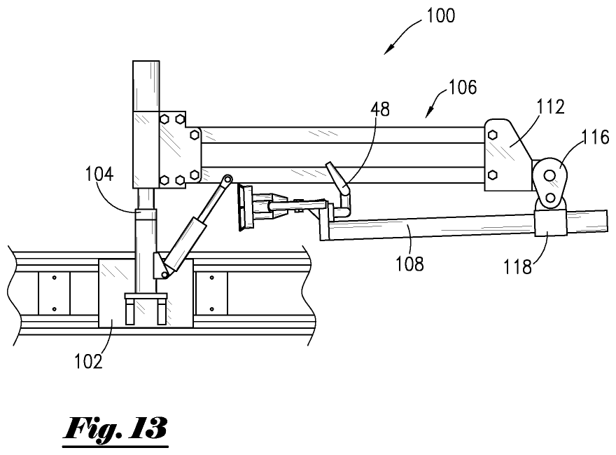

FIG. 11 illustrates another alternate embodiment of the tank system. Tank system 100 includes the same features and components, and functions in the same way, as tank system 10 except as otherwise described. Tank system 100 includes trolley 102, swivel frame 104 rotatably attached to trolley 102, primary arm 106 affixed to swivel frame 104, and secondary arm 108 rotatably connected to primary arm 106. Primary arm 106 includes proximal bracket 110, distal bracket 112, and parallel members 114 pivotally connected therebetween. Primary arm 106 may be configured to pivot in a vertical direction. Secondary arm 108 may be connected to primary arm 106 through pivot connection 116 and swivel connection 118. Pivot connection 116 may be formed of any connection configured to allow a pivoting motion between two members, such as a hinge or pneumatic valves. Swivel connection 118 may be formed of any metal bearings, such as a roto bearing. Swivel connection 118 may provide for rotation of secondary arm 108 relative to primary arm 106, along with vertical movement of secondary arm 108 relative to primary arm 106. Secondary arm 108 may be formed of a single member. Distal end 120 of secondary arm 108 may include a mounting bracket 122 configured to secure a submersible pump, such as submersible pump 46, to the distal end 120. At least one nozzle, such as recirculation nozzle 48 or cleaning nozzle 50, is secured to primary arm 106 or secondary arm 108.

As shown in FIG. 11, primary arm 106 may be pivoted in a vertical direction. Primary arm 106 may also be rotated in a horizontal plane relative to trolley 102. Secondary arm 108 may be rotated in a horizontal plane relative to primary arm 106. These relative rotations, vertical movement, and the movement of trolley 102 along a track system, such as track assembly 12, may allow a submersible pump and a nozzle mounted on primary arm and/or secondary arm to reach all areas within a tank.

With reference to FIG. 13, tank system 100 may be placed in a storage position by placing primary arm 106 in a parallel or neutral position and by pivoting secondary arm 108 relative to primary arm 106 through pivot connection 116.

Tank systems 10, 80, and 100 may each be used in any enclosure and may be configured for mixing, pumping, and/or cleaning operations involving any fluid, especially those including solid or gel components.

While preferred embodiments have been described, it is to be understood that the embodiments are illustrative only and that the scope of the invention is to be defined solely by the appended claims when accorded a full range of equivalents, many variations and modifications naturally occurring to those skilled in the art from a review hereof.

I claim:

1. An integrated system for managing a fluid in an enclosure, comprising:
a trolley configured for connection to and movement along a track system mounted within the enclosure;
a primary arm operatively connected to the trolley, wherein the primary arm rotates 360 degrees in a horizontal plane relative to the trolley, and wherein the primary arm includes a pivot frame for pivoting the primary arm in a vertical plane;
a secondary arm operatively connected to the primary arm, wherein the secondary arm rotates at least 340 degrees in a horizontal plane relative to the primary arm;
a submersible pump mounted to the secondary arm; and
at least one nozzle mounted to the secondary arm.

2. The integrated system of claim 1, further comprising a swivel frame connecting the primary arm and the trolley.

3. The integrated system of claim 2, wherein the pivot frame of the primary arm includes a proximal bracket, a distal bracket, two parallel members each pivotally mounted to the proximal bracket and pivotally mounted to the distal bracket, and a cylinder assembly pivotally mounted to the proximal bracket and a portion of one of the parallel members.

4. The integrated system of claim 3, wherein extension of the cylinder assembly pivots the primary arm in the vertical plane to lower the distal bracket of the primary arm, and wherein retraction of the cylinder assembly pivots the primary arm in the vertical plane to raise the distal bracket of the primary arm.

5. The integrated system of claim 3, wherein extension of the cylinder assembly pivots the primary arm in the vertical plane to raise the distal bracket of the primary arm, and wherein retraction of the cylinder assembly pivots the primary arm in the vertical plane to lower the distal bracket of the primary arm.

6. The integrated system of claim 3, wherein the secondary arm includes a horizontal member and a vertical member, wherein a proximal end of the horizontal member is connected to the distal bracket of the primary arm through a pivot connection, and wherein a proximal end of the vertical member is connected to a distal end of the horizontal member.

7. The integrated system of claim 6, wherein the submersible pump is mounted to a distal end of the vertical member of the secondary arm.

8. The integrated system of claim 7, wherein the at least one nozzle includes a cleaning nozzle mounted to the horizontal member of the secondary arm, the cleaning nozzle including at least one fluid outlet rotatably mounted to a nozzle frame.

9. The integrated system of claim 8, wherein the at least one fluid outlet of the cleaning nozzle includes two fluid outlets mounted 180 degrees from one another.

10. The integrated system of claim 8, further comprising an inlet fluid line in fluid communication with the cleaning nozzle.

11. The integrated system of claim 7, wherein the at least one nozzle includes a recirculation nozzle mounted to the horizontal member of the secondary arm.

12. The integrated system of claim 11, further comprising:
a valve including an inlet, a first outlet, and a second outlet, wherein the inlet is in fluid communication with the submersible pump, and wherein the first outlet is in fluid communication with the recirculation nozzle; and
an outlet fluid line in fluid communication with the second outlet;
wherein in a first position the valve directs a fluid flow from the submersible pump to the recirculation nozzle, and wherein in a second position the valve directs the fluid flow from the submersible pump to the outlet fluid line.

13. The integrated system of claim 3, wherein the secondary arm is connected to the distal bracket of the primary arm through a pivot connection and a swivel connection, wherein the secondary arm pivots in a vertical plane relative to the primary arm to place the integrated system in a storage position, and wherein the submersible pump is mounted to a distal end of the secondary arm.

14. The integrated system of claim 1, wherein the track system is magnetically mounted within an enclosure.

15. An integrated system for managing a fluid in an enclosure, comprising:
a trolley configured for connection to and movement along a track system mounted within the enclosure;
a swivel frame mounted to the trolley;
a primary arm mounted to the swivel frame, wherein the primary arm rotates 360 degrees in a horizontal plane relative to the trolley, wherein the primary arm includes a pivot frame for pivoting the primary arm in a vertical plane, and wherein the pivot frame includes a proximal bracket, a distal bracket, two parallel members each pivotally mounted to the proximal bracket and pivotally mounted to the distal bracket, and a cylinder assembly pivotally mounted to the proximal bracket and a portion of one of the parallel members;
a secondary arm including a horizontal member and a vertical member, wherein a proximal end of the horizontal member connected to the distal bracket of the primary arm through a pivot connection, wherein a proximal end of the vertical member is connected to a distal end of the horizontal member, and wherein the secondary arm rotates at least 340 degrees in a horizontal plane relative to the primary arm;
a submersible pump mounted to a distal end of the vertical member of the secondary arm;
a recirculation nozzle mounted to the secondary arm;
a cleaning nozzle mounted to the secondary arm, wherein the cleaning nozzle includes at least one fluid outlet rotatably mounted to a nozzle frame; and
a valve including an inlet, a first outlet, and a second outlet, wherein the inlet is in fluid communication with the submersible pump, wherein the first outlet is in fluid communication with the recirculation nozzle, wherein the valve is configured to direct a fluid flow from the submersible pump to the first outlet in a first position and to the second outlet in the second position.

16. The integrated system of claim 15, further comprising:
an inlet fluid line in fluid communication with the cleaning nozzle; and
an outlet fluid line in fluid communication with the second outlet of the valve;
wherein in a first position the valve directs a fluid flow from the submersible pump to the recirculation nozzle, and wherein in a second position the valve directs the fluid flow from the submersible pump to the outlet fluid line.

17. A method for managing a fluid within an enclosure, comprising the steps of:
a) providing an integrated system comprising: a trolley configured for connection to and movement along a track system mounted within the enclosure; a primary arm operatively connected to the trolley, wherein the primary arm rotates 360 degrees in a horizontal plane relative to the trolley, and wherein the primary arm includes a pivot frame for pivoting the primary arm in a vertical plane; a secondary arm operatively connected to the primary arm, wherein the secondary arm rotates at least 340 degrees in a horizontal plane relative to the primary arm; a submersible pump mounted to the secondary arm; a recirculation nozzle mounted to the secondary arm; and a cleaning nozzle mounted to the secondary arm, wherein the cleaning nozzle includes at least one fluid outlet rotatably mounted to a nozzle frame;
b) mounting the integrated system within an enclosure by securing the trolley to the track system within the enclosure; and
c) positioning the submersible pump at least partially within a fluid contained in the enclosure.

18. The method of claim 17, wherein the integrated system further comprises a control system including at least a detection system and a software program operating in a CPU, and wherein step (c) further comprises:
i) receiving, with the software program, one or more dimensions of the enclosure;
ii) directing, with the software program, a movement of the integrated system within the enclosure based on the dimensions.

19. The method of claim 18, wherein step (c) further comprises:
iii) measuring, with the detection system, a characteristic measurement of the enclosure content;
iv) receiving, with the software program, the characteristic measurement of the enclosure content;
v) directing, with the software program, the control system to adjust at least one setting of the integrated system in response to the characteristic measurement.

20. The method of claim 17, wherein the primary arm is rotated relative to the trolley or the secondary arm is rotated relative to the primary arm to move the submersible pump within the enclosure, and the trolley is moved along the track system.

21. The method of claim 20, further comprising the step of:
d) mixing the fluid within the enclosure by pumping the fluid into the submersible pump and through the recirculation nozzle to return the fluid to the enclosure.

22. The method of claim 20, further comprising the step of:
d) pumping the fluid out of the enclosure by pumping the fluid into the submersible pump and through an outlet fluid line.

23. The method of claim 20, further comprising the step of:
d) feeding a cleaning fluid through an inlet fluid line and through the cleaning nozzle to clean the interior surfaces of the enclosure.
